(19) United States
(12) Patent Application Publication
(10) Pub. No.: US 2023/0246583 A1
(43) Pub. Date: Aug. 3, 2023

(54) ELECTRICITY GENERATING MODULE

(71) Applicant: ACPV, Paris (FR)

(72) Inventors: André SASSI, RUEIL MALMAISON (FR); Jocelyne SASSI, RUEIL MALMAISON (FR)

(73) Assignee: ACPV, Paris (FR)

(21) Appl. No.: 18/024,435

(22) PCT Filed: Sep. 3, 2021
(86) PCT No.: PCT/FR2021/051513

§ 371 Date: Mar. 2, 2023

(30) Foreign Application Priority Data
Sep. 3, 2020 (FR) FR2008943

(51) Int. Cl. H02S 10/12; H02J 7/35; A01M 29/22; A01M 29/16; A01M 29/26

(52) U.S. Cl. CPC H02S 10/12; A01M 29/16; A01M 29/22; A01M 29/26; H02J 7/35; H02S 20/23

(57) ABSTRACT

An electricity production module comprising at least one photovoltaic panel (P), characterized in that it further comprises scaring means (E) for chasing away animals, and in particular birds, and detection means (D) capable of detecting the presence of animals that are close to or on the photovoltaic panel (P), the detection means (D), in the presence of an animal, delivering a presence signal capable of triggering the scaring means (E).

The present invention relates to an electricity generating module comprising one or more photovoltaic panels.

There are already rigid or flexible photovoltaic panels that can be installed on roofs or structures provided for this purpose, as in solar farms.

In general, photovoltaic panels are not installed in urban areas. In addition, they are implemented either on an individual scale (house) or on an industrial scale (solar farms or wind farms): the intermediate scale has been neglected and hardly exists or does not exist.

In any case, the cleanliness of the photovoltaic panels is a important requirement, because it allows to keep the yield of the photovoltaic panels at a maximum level. Specifically, a partial covering of the photovoltaic panels with sheets considerably reduces their yield. However, the sheets are easy to remove, as they do not adhere to photovoltaic panels. Most of the time, it is the wind that will rid the photovoltaic panels of the leaves. It is not the same with the droppings of birds, which spread and adhere to photovoltaic panels. Removing them is complicated because it requires the use of mechanical or high-pressure cleaning.

An object of the present invention is to prevent birds from depositing their droppings on a photovoltaic panel.

To do this, the present invention proposes an electricity generating module comprising at least one photovoltaic panel, detection means capable of detecting the presence of animals that are close to or on the photovoltaic panel, and scaring means for chasing away animals, and in particular birds, the detection means, in the presence of an animal, delivering a presence signal capable of triggering the scaring means, characterized in that it further comprises at least one mast on which the photovoltaic panel is mounted, the detection means and/or the scaring means being mounted on the mast.

¹Translation of the title as established ex officio.

Thus, the invention results from the combination of two distinct means, namely scaring means and detection means for triggering the scaring means, all associated with a photovoltaic panel, in order to keep it free from avian droppings. The photovoltaic panel, the scaring means, and the detection means are mounted on a support mast.

Advantageously, the detection means and/or the scaring means are mounted at the top of the mast.

In an embodiment, the mast extends above the photovoltaic panel to support the detection means and/or the scaring means. Preferably, the detection means and/or the scaring means are housed in a housing that is mounted at the end of a mast, the housing advantageously having a cross-section that is substantially identical to that of the mast. The extension of the mast above the photovoltaic panel can thus be formed by the housing containing the detection means and/or the scaring means.

Advantageously, the detection means are selected from motion sensors, photoelectric sensors, and camera sensors associated with an image analysis system.

In parallel, the scaring means may be chosen from vibrations, sounds, images, electric discharges, wind turbines, movements (articulated and controlled scarecrow), alone or in combination. Preferably, several different scaring means may be implemented cumulatively or successively, advantageously in random manner. The aim is to diversify the means of scaring as much as possible, so as not to create habituation for the birds.

According to a practical embodiment, the scaring means may be located between the mast and the photovoltaic panel. The scaring means may be vibration means mounted on the mast and vibratingly engaging the photovoltaic panel.

In another aspect of the invention, sprinklers may be provided on the mast for cleaning the photovoltaic panel.

The module may also comprise an electrical storage unit for storing at least some of the electricity from the photovoltaic panel and the wind turbine. The module may also comprise at least one electrical charging terminal for charging rechargeable electric vehicles, the electrical charging terminal being installed on the mast, below the photovoltaic panel.

With wind turbines as scaring means, a particularly advantageous relative arrangement exists, namely that the wind turbine(s) is arranged close to and above the photovoltaic panels. In other words, the wind turbines overhang the photovoltaic panels from above. This particular relative arrangement provides several advantages. Firstly, the wind turbines keep birds away, so that they do not dump their excrement on the photovoltaic panels. The birds will also not nest on or in the electrical-power generating module, as they are deterred by the wind turbines. This is particularly true in the city, where large colonies of pigeons live. Secondly, the wind turbines will permanently clean the photovoltaic panels by the airflow that they create: this prevents dust and leaves (or any other light particles) from accumulating on the photovoltaic panels. Thirdly, when photovoltaic panels are cleaned with water or when it rains on them, the wind turbines drive the water away from the photovoltaic panels, which contributes to their cleanliness. The blade tips of the wind turbines may pass within one meter of the photovoltaic panels, or within 50 cm, advantageously within 20 cm or even within 10 cm.

The scope of the invention resides in integrating the detection and/or scaring means in one (or more) masts that also support the photovoltaic panel (s) . The housing, containing the detection and/or scaring means, makes it possible to extend the mast in an aesthetic manner.

The invention is described more fully below, with reference to the accompanying drawings which show two embodiments of the invention by way of non-limiting examples.

In the figures:

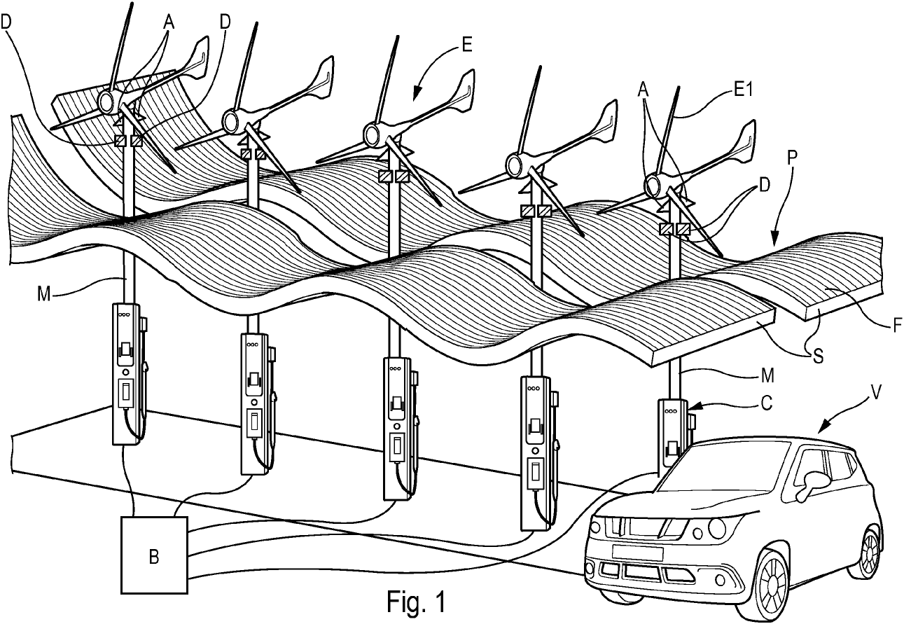

FIG. 1 is a perspective view of an electricity generating module according to a first embodiment of the invention implementing wind turbines as scaring means,

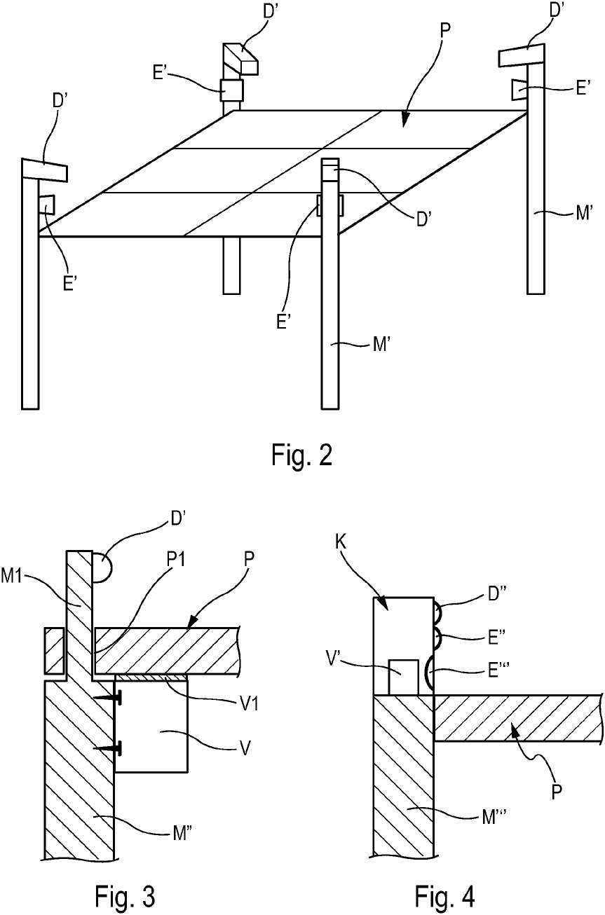

FIG. 2 is a schematic, perspective view of an electricity generating module according to a second embodiment of the invention, and

FIG. 3 is an enlarged sectional view showing a detail of the electricity generating module according to a second embodiment of the invention, implementing a vibrator as scaring means, and

FIG. 4 is a schematic, perspective view of an electricity generating module according to an alternative embodiment of the invention.

Reference is made firstly to FIG. 1 in order to describe in detail an electrical-power generating module of the invention which is in the form of an electric charging station for an electric vehicle. Consequently, this electrical-power generating module is more for urban use (large cities, large towns, medium-sized towns, small towns, villages).

In FIG. 1, it can be seen that the electricity generating module is in the form of a station including five wind turbines E and two large photovoltaic panels P. This charging station can be installed both in the city and in the countryside, in particular to deal with the problem of the isolation of the territories and to distribute the electric cars evenly. The wind turbines E are installed at the top of masts M which are anchored in the ground. These masts M also serve as supports for the two photovoltaic panels P. The masts M also serve as supports for charging terminals C which are installed close to the ground or at ground level. The user of an electric vehicle V can thus charge the battery of their vehicle at one of the charging terminals C. When the electrical-power generating module is installed along a pavement, it can also be used for charging push scooters, bicycles, motor scooters and hoverboards.

The wind turbines E each comprise three blades E1, which are intended to be rotated by wind. The wind turbines E are mobile in rotation on their respective mast M, so as to adapt to the direction of the wind. The wind turbines E are of average size, and are advantageously extremely silent. The length of the blades E1 advantageously does not exceed 0.5 metres.

In FIG. 1, it can be noted that the wind turbines E are disposed above the panels P at a distance of 1 to 2 metres. The tip E11 of the blades E1 can pass within 20 centimetres of the surfaces P. Thus, by rotating, the blades E1 of the wind turbines E create airflows that will sweep the upper surface of the photovoltaic surfaces P. These airflows will thus remove any object (leaves or dust) from the surfaces P that would be deposited therein. The airflows also repel rain or cleaning water which could stagnate on the photovoltaic panels P. On the other hand, the wind turbines E act as a “scarecrow” for the birds which thus remain away from the photovoltaic panels P. The wind turbines E thus fulfil a threefold function of scaring, sweeping and drying for the photovoltaic panels P, simply being disposed close to and above the panels.

It can be seen in FIG. 1 that the electrical charging station here comprises two photovoltaic panels P. The panels P are profiled, in particular undulating. Each panel P comprises a support structure S which is rigid and undulated. For example, the support structure S may be made from extremely lightweight composite materials.

It may be noted that the undulation of the support structure S is not random, but results from the joining of parallel cylinder segments or straight lines.

Photovoltaic sensors are disposed on the support structure S according to its profiled shape. Advantageously, the photovoltaic sensors are in the form of a semi-flexible or flexible and thin photovoltaic film that will closely match the profiled shape of the support structure S. The photovoltaic film may be of the polymer-based organic type, such as that commercialised by the company ARMOR under the trademark ASCA®. The semi-flexible photovoltaic panel may be that commercialised by the company SunPower®. The photovoltaic film F covers the upper face of the support structures S, but can also cover the lower face, as well as the side edges. Indeed, this photovoltaic film F is particularly sensitive to light, and this light also reaches the lower face of the support structure S. It is thus possible to design photovoltaic panels P comprising a support structure S entirely coated with the photovoltaic film F. It is also possible to choose the colour of the photovoltaic film according to the installation location: for example, green in the countryside, another colour of choice for cities and a sand colour for barren or desert areas.

According to the invention, this electricity generating module also comprises detection means D, which are advantageously mounted on the masts M. The detection means may be of any kind and use any appropriate technology. By way of example, the detection means D may be in the form of presence or motion sensors, photoelectric sensors (e.g. infrared sensors), or camera sensors associated with an image analysis system. Their purpose is to detect the presence or arrival of one or more birds in the vicinity of, above, below or on the photovoltaic panels P. For example, two sensors can be mounted on each mast M, below or above a wind turbine E. These sensors will thus detect the presence or arrival of a bird in the vicinity of the photovoltaic panels P and deliver a presence signal to a processing and control unit which will send an activation signal to one or more of the wind turbines E so that they begin to rotate with the wind or even in the absence of wind. The processing and control unit can thus control the operation of the wind turbines for a short period of time, which may be of the order of a few seconds to a few minutes.

The electrical charging station in FIG. 1 of course comprises all the equipment necessary to be able to inject the electricity generated into the domestic grid. In particular, this equipment may comprise one or more inverters. The station may also comprise an electrical storage unit B, which may be in the form of an accumulator or battery, thus making it possible to store a portion of the electricity produced, in particular in order to power the detection means D, the charging terminals C and the motors making it possible to pivot the wind turbines E. The electrical storage unit B may also control sprinklers or cleaning nozzles A, for example installed on the masts M close to their upper end, as can be seen in FIG. 1. Thus, the photovoltaic panels P can be cleaned automatically using these sprinklers A, and then dried by the wind turbines E. Thus, a completely autonomous electrical charging station is had, both in terms of electricity and in terms of cleaning means for the photovoltaic panels P. Of course, the charging terminals C can also be supplied with mains electricity, in particular when the electrical-power generation from the wind turbines and from the photovoltaic panels P is insufficient. Furthermore, the wind turbines E can be powered and activated by the electrical storage unit B when there is no wind to perform their scaring function.

In this first embodiment, the wind turbines E perform the function of scaring means for chasing away birds. Scaring is obtained by the displacement of the blades of the wind turbines: it can be said that it is a mechanical scaring by movement of a physical element. Without going beyond the scope of the invention, the wind turbines E can be replaced or supplemented by any other appropriate scaring means. Vibrations include sounds (raptors’ cry -ultrasound), images (hologram), weak electric discharges, and of course any movement, such as for example that of an articulated and controlled scarecrow.

FIG. 2 shows another electrical generating module of the invention, in which a photovoltaic panel P is supported by four masts M′, in the manner of a pergola or a gazebo. Specifically, the four masts M′ are located at the four corners of the photovoltaic panel P, which may for example be composed of six assembled panel elements. The masts M′ can extend upwards beyond the photovoltaic panel P or flush with the photovoltaic panel P. Above the flush masts or in the overhanging part of the masts, the masts M′ are at least for some provided with detection means D′ and scaring means E′. The detection means D′ can be mounted at the top of the mast M′ and the scaring means E′ just below. The detection means D′ can be presence or motion sensors, photoelectric sensors (for example infrared) or camera sensors associated with an image analysis system. The scaring means E′ can use vibrations, sounds (raptors’ cry – ultrasound), images (hologram), weak electric discharges, and of course any movement. It is advantageous to mix up the scaring means and even to trigger them randomly so as not to accustom the birds.

FIG. 3 shows a mast M″ that supports a photovoltaic panel P. The mast M″ forms an upper guide rod M1 and the photovoltaic panel P comprises a bore P1 in which the upper guide rod M1 is engaged, while allowing the photovoltaic panel P to slide axially. The mast M″ supports a vibrator V that comprises a vibrating pad V1 that is in contact with the photovoltaic panel P, so as to apply vibrations to it, which have the effect of moving the photovoltaic panel P vertically back and forth along the upper guide rod M1. The top of the rod M1 supports detection means D′, which may be selected from those of the two preceding embodiments. Thus, as soon as the detection means D′ detect the presence of a bird, a presence signal is sent directly or indirectly to the vibrator V, which is activated to cause the photovoltaic panel P to vibrate. The vibration of the panel is preferably short, of the order of a few seconds, which are sufficient to put the bird on the run.

FIG. 4 shows a mast M‴ that supports a photovoltaic panel P and that is capped, at its top, by a housing K that contains detection means D′ ′, as well as scaring means V′, E″ and E‴, which may be a vibrator V′, a flash E″ and/or a sound (raptor’s cry). It may be observed that the top of the mast M‴ is located substantially at the same level as the photovoltaic panel P, and that the housing K extends the mast M‴ above the photovoltaic panel P. For aesthetic reasons, the housing K may present a horizontal cross-section that is substantially or completely identical to that of the mast M‴. By way of ′example, the housing may be made from a mast section, such that it is perfectly and imperceptibly integrated into the mast. In practice, it suffices to equip a single mast M‴ with the housing K, but it is very well possible to equip several masts.

By means of the invention, an electrical generating module is provided, the photovoltaic panel or panels P of which are effectively protected from the droppings of birds.

1. An electricity generating module comprising at least one photovoltaic panel (P), detection means (D; D′) suitable for detecting the presence of animals that are close to or on the photovoltaic panel (P), and scaring means (E; E′; V) for scaring the animals, and in particular the birds, the detection means (D; D′), in the presence of an animal, delivering a presence signal suitable for triggering the scaring means (E; E′; V),
characterised in that it further comprises at least one mast (M; M′; M″) on which the photovoltaic panel (P) is mounted, the detection means (D; D′) and/or the scaring means (E; E′) being mounted on the mast (M; M′; M″).

2. The module according to claim 1, wherein the detection means (D; D′) and/or the scaring means (E; E′) are mounted at the top of the mast (M; M′; M″).

3. The module according to claim 1, wherein the mast (M; M′; M″) extends above the photovoltaic panel (P) to support the detection means (D; D′) and/or the scaring means (E; E′).

4. The module according to claim 1, wherein a plurality of different scaring means (E; E′; V) are implemented randomly, cumulatively, or successively.

5. The module according to claim 1, wherein the detection means (D; D′) are selected from motion sensors, photoelectric sensors, and camera sensors associated with an image analysis system.

6. The module according to claim 1, wherein the scaring means (E; E′; V) are selected from vibrations, sounds, images, electrical discharges, wind turbines, movements (articulated and controlled scarecrow), alone or in combination.

7. The module according to claim 1, further comprising at least one mast (M″) on which the photovoltaic panel (P) is mounted, the scaring means (V) being situated between the mast (M″) and the photovoltaic panel (P).

8. The module according to claim 7, wherein the scaring means are vibration means (V) mounted on the mast (M″) and vibratingly engaging the photovoltaic panel (P).

9. The module according to claim 1, further comprising at least one mast (M) on which the photovoltaic panel (P) is mounted, sprinklers (A) being provided on the mast (M) for cleaning the photovoltaic panel (P).

10. The module according to claim 1, comprising an electrical storage unit (B) for storing at least some of the electricity from the photovoltaic panel (P).

11. The module according to claim 1, comprising at least one electrical charging terminal (C) for charging rechargeable electric vehicles (V), the electrical charging terminal (C) being installed below the photovoltaic panel (P).

12. The module according to claim 1, wherein the detection means (D; D′) and/or the scaring means (E; E′) are housed in a housing (K) that is mounted at the end of a mast (M; M′; M″), the housing (K) advantageously having a cross-section that is substantially identical to that of the mast (M; M′; M″).

13. The module according to claim 12, wherein the housing (K) is made from a mast section (M; M′; M″).

14. The module according to claim 12, comprising a plurality of masts (M; M′; M″), at least one mast (M; M′; M″) being equipped with a housing (K).
